(19) United States
(12) Patent Application Publication
(10) Pub. No.: US 2023/0147201 A1
(43) Pub. Date: May 11, 2023

(54) INDICATION OF RESOURCE CONFLICT

(71) Applicant: Nokia Technologies Oy, Espoo (FI)

(72) Inventors: Daniel MEDINA, Munich (DE); Torsten Wildschek, Gloucester (GB); Berthold Panzner, Holzkirchen (DE); Stepan Kucera, Munich (DE); Prajwal Keshavamurthy, Munich (DE)

(21) Appl. No.: 18/047,939

(22) Filed: Oct. 19, 2022

Related U.S. Application Data
(60) Provisional application No. 63/277,695, filed on Nov. 10, 2021.

(51) Int. Cl. H04W 72/04; H04W 72/08

(52) U.S. Cl. CPC H04W 72/0406; H04W 72/085

(57) ABSTRACT

There is provided a method, comprising: receiving a first SCI from a first device indicating a first reserved radio resource for transmission by the first device; receiving a second SCI from a second device indicating a second reserved radio resource for transmission by the second device, the first and second reserved radio resource overlapping at least partially; determining a first and second received signal strength associated with the received first and second SCI respectively; determining at least one of a first MCS applied by the first device or a second MCS applied by the second device; determining, based on the first MCS and/or the second MCS, at least one threshold; and determining, based on the at least one threshold and the first and second received signal strengths, whether or not to transmit a resource conflict indication to at least one of the first device or the second device.

### RELATED APPLICATION

This application claims priority from U.S. provisional application No. 63/277,695 filed on Nov. 10, 2021, which is hereby incorporated in its entirety.

### TECHNICAL FIELD

Various example embodiments relate generally to determining whether or not to indicate a resource conflict, e.g., in New Radio (NR) sidelink.

### BACKGROUND

It is possible that two devices reserve overlapping radio resources for sidelink transmission. In such case, decoding the data of the first sidelink transmission correctly may be difficult, as the second sidelink transmission is interfering with the first. In order to avoid this, an indication about the presence of a resource conflict may be sent to one or both of the devices. However, even when the reserved resources overlap, there are occasions where a reception can be successful, and no resource conflict indication is needed.

### BRIEF DESCRIPTION

According to some aspects, there is provided the subject matter of the independent claims. Some further aspects are defined in the dependent claims.

### LIST OF THE DRAWINGS

In the following, the invention will be described in greater detail with reference to the embodiments and the accompanying drawings, in which

FIG. 1 presents a network, according to an embodiment;

FIG. 2A depicts how a user equipment may detect a resource overlap and indicate the resource conflict, according to an embodiment;

FIG. 2B depicts how the resources may overlap, according to an embodiment;

FIG. 3 shows a method, according to an embodiment;

FIGS. 4 and 6 illustrate mapping tables, according to some embodiments;

FIG. 5 shows how to derive information regarding how much the resources overlap, according to some embodiments;

FIG. 7 illustrates how to decide whether or not to transmit the resource conflict indication, according to an embodiment;

FIGS. 8 and 9 show signaling flow diagrams, according to some embodiments;

FIG. 10 shows an apparatus, according to an embodiment.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. For the purposes of the present disclosure, the phrases “at least one of A or B”, “at least one of A and B”, “A and/or B” means (A), (B), or (A and B). For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

Embodiments described may be implemented in a radio system, such as one comprising at least one of the following radio access technologies (RATs): Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (H SPA), Long Term Evolution (LTE), LTE-Advanced, and enhanced LTE (eLTE). Term ‘eLTE’ here denotes the LTE evolution that connects to a 5G core. LTE is also known as evolved UMTS terrestrial radio access (EUTRA) or as evolved UMTS terrestrial radio access network (EUTRAN). A term “resource” may refer to radio resources, such as a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources

The embodiments are not, however, restricted to the systems/RATs given as an example but a person skilled in the art may apply the solution to other communication systems provided with necessary properties. One example of a suitable communications system is the 5G system. The 3GPP solution to 5G is referred to as New Radio (NR). 5G has been envisaged to use multiple-input-multiple-output (MIMO) multi-antenna transmission techniques, more base stations or nodes than the current network deployments of LTE (a so-called small cell concept), including macro sites operating in co-operation with smaller local area access nodes and perhaps also employing a variety of radio technologies for better coverage and enhanced data rates. 5G will likely be comprised of more than one radio access technology/radio access network (RAT/RAN), each optimized for certain use cases and/or spectrum. 5G mobile communications may have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and being integrable with existing legacy radio access technologies, such as the LTE.

The current architecture in LTE networks is distributed in the radio and centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications). Edge cloud may be brought into RAN by utilizing network function virtualization (NVF) and software defined networking (SDN). Using edge cloud may mean access node operations to be carried out, at least partly, in a server, host or node operationally coupled to a remote radio head or base station comprising radio parts. Network slicing allows multiple virtual networks to be created on top of a common shared physical infrastructure. The virtual networks are then customised to meet the specific needs of applications, services, devices, customers or operators.

In radio communications, node operations may be carried out, at least partly, in a central/centralized unit, CU, (e.g., server, host or node) operationally coupled to distributed unit, DU, (e.g., a radio head/node). It is also possible that node operations will be distributed among a plurality of servers, nodes or hosts. It should also be understood that the distribution of labour between core network operations and base station operations may vary depending on implementation. Thus, 5G networks architecture may be based on a so-called CU-DU split. One gNBCU controls several gNB-DUs. The term ‘gNB’ may correspond in 5G to the eNB in LTE. The gNBs (one or more) may communicate with one or more UEs. The gNBCU (central node) may control a plurality of spatially separated gNB-DUs, acting at least as transmit/receive (Tx/Rx) nodes. In some embodiments, however, the gNBDUs (also called DU) may comprise e.g., a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) and an internet protocol (IP) layers. Other functional splits are possible too. It is considered that skilled person is familiar with the OSI model and the functionalities within each layer.

In an embodiment, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU and the boundary where the responsibility is shifted between the CU and the DU may be selected according to implementation.

Some other technology advancements probably to be used are Software-Defined Networking (SDN), Big Data, and all-IP, to mention only a few nonlimiting examples. For example, network slicing may be a form of virtual network architecture using the same principles behind software defined networking (SDN) and network functions virtualisation (NFV) in fixed networks. SDN and NFV may deliver greater network flexibility by allowing traditional network architectures to be partitioned into virtual elements that can be linked (also through software). Network slicing allows multiple virtual networks to be created on top of a common shared physical infrastructure. The virtual networks are then customised to meet the specific needs of applications, services, devices, customers or operators.

The plurality of gNBs (access points/nodes), each comprising the CU and one or more DUs, may be connected to each other via the Xn interface over which the gNBs may negotiate. The gNBs may also be connected over next generation (NG) interfaces to a 5G core network (SGC), which may be a 5G equivalent for the core network of LTE. Such 5G CU-DU split architecture may be implemented using cloud/server so that the CU having higher layers locates in the cloud and the DU is closer to or comprises actual radio and antenna unit. There are similar plans ongoing for LTE/LTE-A/eLTE as well. When both eLTE and 5G will use similar architecture in a same cloud hardware (HW), the next step may be to combine software (SW) so that one common SW controls both radio access networks/technologies (RAN/RAT). This may allow then new ways to control radio resources of both RANs. Furthermore, it may be possible to have configurations where the full protocol stack is controlled by the same HW and handled by the same radio unit as the CU.

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future rail-way/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

The embodiments may be also applicable to narrow-band (NB) Internet-of-things (IoT) systems which may enable a wide range of devices and services to be connected using cellular telecommunications bands. NB-IoT is a narrowband radio technology designed for the Internet of Things (IoT) and is one of technologies standardized by the 3rd Generation Partnership Project (3GPP). Other 3GPP IoT technologies also suitable to implement the embodiments include machine type communication (MTC) and eMTC (enhanced Machine-Type Communication). NB-IoT focuses specifically on low cost, long battery life, and enabling a large number of connected devices. The NB-IoT technology is deployed “in-band” in spectrum allocated to Long Term Evolution (LTE)—using resource blocks within a normal LTE carrier, or in the unused resource blocks within a LTE carrier's guard-band—or “standalone” for deployments in dedicated spectrum.

The embodiments may be also applicable to device-to-device (D2D), machine-to-machine, peer-to-peer (P2P) communications. The embodiments may be also applicable to vehicle-to-vehicle (V2V), vehicle-to-infrastructure (V2I), infrastructure-to-vehicle (I2V), or in general to V2X or X2V communications.

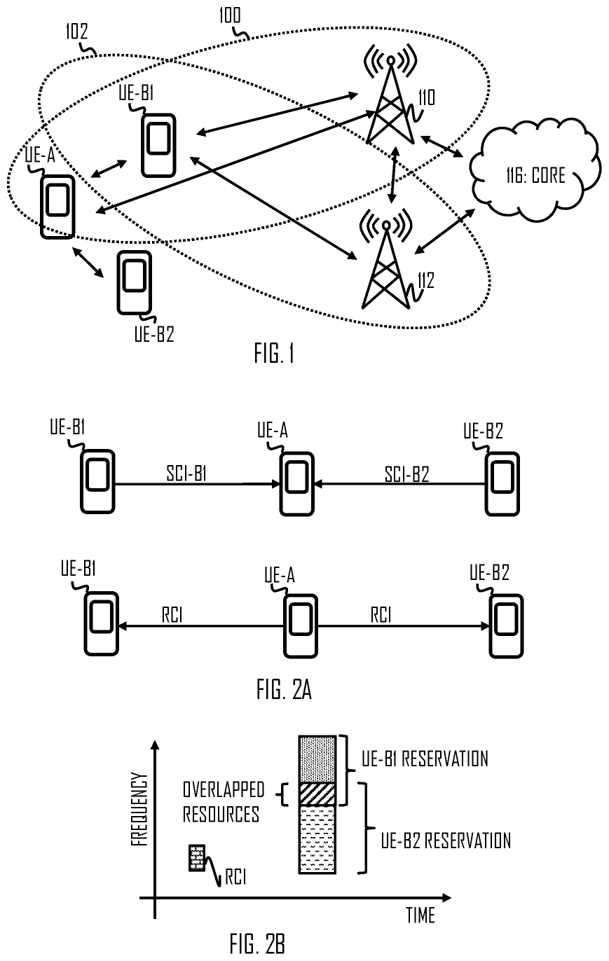

FIG. 1 illustrates an example of a communication system to which embodiments of the invention may be applied. The system may comprise a control node 110 providing one or more cells, such as cell 100, and a control node 112 providing one or more other cells, such as cell 102. Each cell may be, e.g., a macro cell, a micro cell, femto, or a pico cell, for example. In another point of view, the cell may define a coverage area or a service area of the corresponding access node. The control node 110, 112 may be an evolved Node B (eNB) as in the LTE and LTE-A, ng-eNB as in eLTE, gNB of 5G, or any other apparatus capable of controlling radio communication and managing radio resources within a cell. The control node 110, 112 may be called a base station, network node, or an access node.

The system may be a cellular communication system composed of a radio access network of access nodes, each controlling a respective cell or cells. The access node 110 may provide user equipment (UE) UE-A (one or more UEs) with wireless access to other networks such as the Internet. The wireless access may comprise downlink (DL) communication from the control node to the UE-A and uplink (UL) communication from the UE-A to the control node.

Additionally, although not shown, one or more local area access nodes may be arranged such that a cell provided by the local area access node at least partially overlaps the cell of the access node 110 and/or 112. The local area access node may provide wireless access within a sub-cell. Examples of the sub-cell may include a micro, pico and/or femto cell. Typically, the sub-cell provides a hot spot within a macro cell. The operation of the local area access node may be controlled by an access node under whose control area the sub-cell is provided. In general, the control node for the small cell may be likewise called a base station, network node, or an access node.

There may be a plurality of UEs A, B1, B2, . . . in the system. Each of them may be served by the same or by different control nodes 110, 112, or the UE may be in idle or inactive state. The UE-A, UE-B1, UE-B2 may communicate with each other directly, in case a D2D communication interface (e.g., sidelink) is established between them.

The term “terminal device” or “UE” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the case of multiple access nodes in the communication network, the access nodes may be connected to each other with an interface. LTE specifications call such an interface as X2 interface. For IEEE 802.11 network (i.e. wireless local area network, WLAN, WiFi), a similar interface Xw may be provided between access points. An interface between an eLTE access point and a 5G access point, or between two 5G access points may be called Xn. Other communication methods between the access nodes may also be possible. The access nodes 110 and 112 may be further connected via another interface to a core network 116 of the cellular communication system. The LTE specifications specify the core network as an evolved packet core (EPC), and the core network may comprise a mobility management entity (MME) and a gateway node. The MME may handle mobility of terminal devices in a tracking area encompassing a plurality of cells and handle signalling connections between the terminal devices and the core network. The gateway node may handle data routing in the core network and to/from the terminal devices. The 5G specifications specify the core network as a 5G core (SGC), and there the core network may comprise e.g., an access and mobility management function (AMF) and a user plane function/gateway (UPF), to mention only a few. The AMF may handle termination of non-access stratum (NAS) signalling, NAS ciphering & integrity protection, registration management, connection management, mobility management, access authentication and authorization, security context management. The UPF node may support packet routing & forwarding, packet inspection and QoS handling, for example.

Standardization is currently discussing NR sidelink enhancements, including Inter-UE Coordination (IUC). Some associated proposals include a UE-A detecting overlapping resource reservations by two or more UEs (B1, B2) and indicating the presence of an expected/potential resource conflict, as shown in FIGS. 2A and 2B. The UE-A may be the intended receiver of one or both of the sidelink transmissions associated with UE-B1 and UE-B2, or the UE-A may not be the intended receiver but detects the overlap of resources.

FIG. 2B shows how the resources may overlap. For example, the transmissions from UE-B1 and UE-B2 may take place at the same time on fully or partially overlapping frequency resources, such as subchannels. The detection of the resource overlap may be due to UE-A detecting sidelink control information (SCI) from UEs B1 and B2, as shown in FIG. 2A. The SCI from UE-B1 may carry information of the resources reserved for transmission by UE-B1, and the SCI from UE-B2 may carry information of the resources reserved for transmission by UE-B2. When the UE-A detects such overlap of resources, the UE-A may send a resource conflict indication (RCI) to one or both of UEs B1 and B2, as shown in FIG. 2A. This may take place using PSFCH (physical sidelink feedback channel) format 0, for example. The indication may be sent before the actual sidelink transmissions on the reserved resources would take place, as shown with the bricked block in FIG. 2B. That is, overlapping resource reservations may trigger UE-A to indicate a potential resource conflict (coordination information) before the conflict occurs.

There are different schemes envisaged for IUC. Regarding condition 2-A-1 of scheme 2, there is a proposal to support the following additional criteria to determine resource(s) where an expected/potential resource conflict occurs: The resource(s) are fully/partially overlapping in time-and-frequency with UE-B2's reserved resource(s) whose RSRP measurement, denoted by X, meets the following condition(s), where Y is the RSRP measurement of UE-B1's reserved resource: Y+Offset1<X<Y+Offset2, where Offset1 and Offset2 may be (pre)configured, and each of the inequalities can be separately enabled and disabled by a (pre)configuration. Offset1 can be negative or positive.

The condition above comprises two inequalities, which may be rewritten, referring to FIG. 2, as follows (ignoring the sign of Offset1)
(1) RSRP_{B1} (dBm)−RSRP_{B2} (dBm)<Offset1 (dB)
(2) RSRP_{B2} (dBm)−RSRP_{B1} (dBm)<Offset2 (dB)

This means that UE-A may indicate a resource conflict when the RSRP ratio (RSRP difference in dB, or any other useable signal quality/strength measure) is below a threshold, also called offset. Here, the RSRP ratio may be considered as a rough estimate of the expected signal-to-interference ratio (SIR) at UE-A, such that:
According to condition (1), a resource conflict is indicated if the (estimated) expected SIR for UE-A's reception of UE-B1's transmission is below a (first) threshold (Offset1). This condition may be applied when UE-A is an intended receiver of UE-B1's transmission.
According to condition (2), a resource conflict is indicated if the (estimated) expected SIR for UE-A's reception of UE-B2's transmission is below a (second) threshold (Offset2). This condition may be applied when UE-A is an intended receiver of UE-B2's transmission.

However, there are some limitations associated with the above approach.

Problem 1 is related to false alarms and missed conflicts. In other words, whether an actual resource conflict occurs depends on how robust UE-B's transmission is (e.g., the MCS used). If the offset(s) are (pre)configured with single value(s), there may be false alarms (i.e., a resource conflict is indicated by UE-A even though UE-B's MCS is robust enough to handle the interference) as well as missed conflicts (i.e., a resource conflict is not indicated even though UE-B's MCS is not robust enough to handle the interference).

Problem 2 is related to the fact that the actual interference depends on the number of overlapping resources (e.g., subchannels). For example, if the number of overlapping resources (e.g., subchannels) is a small fraction of the total number of subchannels used for UE-B1's transmission, the actual interference may be sufficiently low for UE-A's successful reception of UE-B1's transmission. On the other hand, if the number of overlapping subchannels is a large fraction of the total number of subchannels used for UE-B1's transmission, the actual interference may be sufficiently high to disrupt UE-A's reception of UE-B1's transmission.

To at least partially tackle these problems, there is proposed a solution for optimizing the determination of whether or not to send the resource conflict indication.

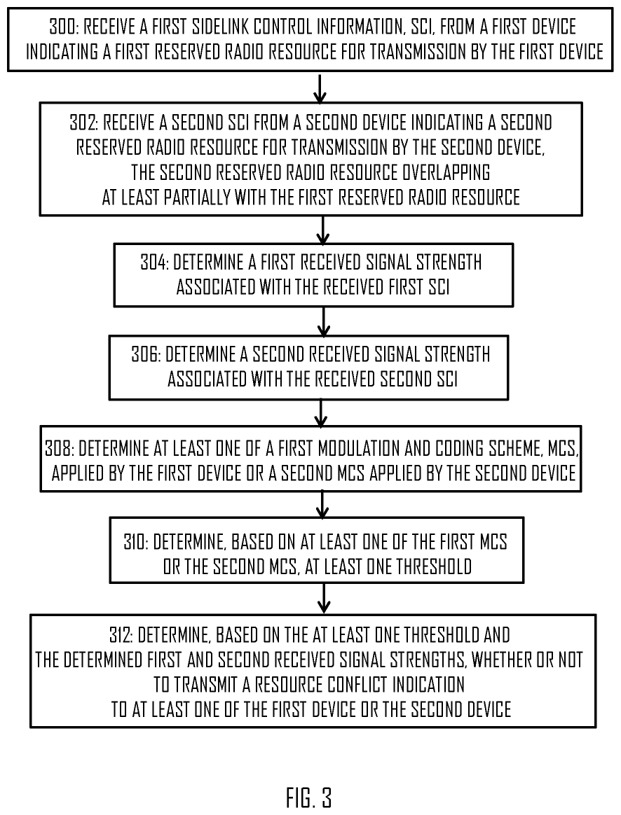

FIG. 3 depicts an example method. The method may be performed by a user equipment, such as UE-A of FIG. 2A, for example. As shown in FIG. 3, the UE-A receives in step 300 a first sidelink control information, SCI, from a first device (e.g., UE-B1) indicating a first reserved radio resource for transmission by the UE-B1. In step 302, the UE-A receives a second SCI from a second device (e.g., UE-B2) indicating a second reserved radio resource for transmission by the UE-B2. Instead of SCI, the resource reservation indication may be carried in any message detectable by the UE-A, such as a MAC-CE, for example.

In an embodiment, the UE-A may be an intended receiver of the SCI and/or the data to be transmitted by the UE-B1 and/or UE-B2 on the respective reserved radio resources. In another embodiment, the UE-A may be able to receive and decode the SCI by monitoring the air interface without being an intended receiver of the SCI and/or the data to be transmitted by the UE-B1 and/or UE-B2 on the respective reserved radio resource.

As shown in FIG. 2B, the second reserved radio resource is overlapping at least partially with the first reserved radio resource. In an embodiment, each reserved radio resource may comprise a block or a set of time-frequency resources elements (REs), and these blocks may be indicated in the SCIs. The reserved resources may overlap only in the time domain, only in the frequency domain, or in both domains. In one embodiment, the spatial domain is also taken into account such that the resource conflict is envisaged to take place only when the transmissions of the UEs B1 and B2 overlap spatially.

In step 304, the UE-A determines a first received signal strength associated with the received first SCI. In step 306, the UE-A determines a second received signal strength associated with the received second SCI. In an embodiment, the first received signal strength comprises a reference signal received power (RSRP) associated with the received first SCI. In an embodiment, the second received signal strength comprises a RSRP associated with the received second SCI. The signal strength may be measured from the associated SCI, for example. In an embodiment, other signal strength/quality measures than RSRP may be determined to reflect the strength of the signals from UE-B1 and/or UE-B2, such as a received signal strength indicator (RSSI).

In step 308, the UE-A determines at least one of a first modulation and coding scheme (MCS) applied by the UE-B1 or a second MCS applied by the UE-B2. In an embodiment, the UE-A may determine the first MCS based on the received first SCI. In an embodiment, the UE-A may determine the second MCS based on the received second SCI. This may comprise the UE-A detecting an indication of the respective MCS in the respective SCI. The UE-A may thus determine only one MCS related to UE-B1 or the UE-B2, or two MCSs related to both UEs. In another embodiment, the UE-A may determine the MCS to be used by the UE-B1 and/or UE-B2 by detecting, e.g., the type of the respective UE or the type of data to be sent, which may imply the MCS to be used.

In step 310, the UE-A determines, based on at least one of the first MCS or the second MCS, at least one threshold. In an embodiment, the UE-A determines a first threshold (e.g., Offset1) associated with the UE-B1 based on the first MCS and/or a second threshold (e.g., Offset2) associated with the UE-B2 based on the second MCS. In an embodiment, the threshold may be associated to the determined received signal strengths. The threshold value may be, e.g., selected from a group of preconfigured thresholds values, which group may be based on empirical data or simulations.

In step 312, the UE-A determines, based on the at least one threshold and the determined first and second received signal strengths, whether or not to transmit a resource conflict indication (RCI) to at least one of the UE-B1 or the UE-B2.

As shown in FIG. 3, in order to enhance the resource conflict indication transmission decision in IUC, it is proposed that the threshold (offset) of above conditions (1) and (2) depend on the MCS used. There are many possible MCSs out of which one may be used by, e.g., UE-B1 in its data transmission on the first reserved resource. Correspondingly, there may be many thresholds available for selection (each corresponding to a specific MCS) out of which the UE-A may select one threshold to be used in relation to UE-B1. When the dependency to MCS is applied to the above conditions (1) and (2), the conditions may be amended as shown below:
(1) RSRP_{B1} (dBm)−RSRP_{B2} (dBm)<Offset1(MCS_{B1}) (dB)
(2) RSRP_{B2} (dBm)−RSRP_{B1} (dBm)<Offset2(MCS_{B2}) (dB)

In an embodiment, a more robust MCS corresponds to a lower threshold, and a less robust MCS corresponds to a higher threshold. In other words, the more robust the MCS used by the UE-B1 is, the less likely it is that the UE-A sends the RCI. For example, if UE-B1 indicates that a robust MCS will be used for its transmission to UE-A, UE-A may apply a smaller offset in condition (1). Similarly, the less robust the MCS used by the UE-B1 is, the more likely it is that the UE-A sends the RCI. For example, if UE-B1 indicates a weak MCS to be used in its transmission on the first reserved radio resource, the UE-A may apply a larger offset. The same logic is applied to condition (2), i.e., it is made dependent on the MCS used by the UE-B2 in its transmission on the second reserved radio resource.

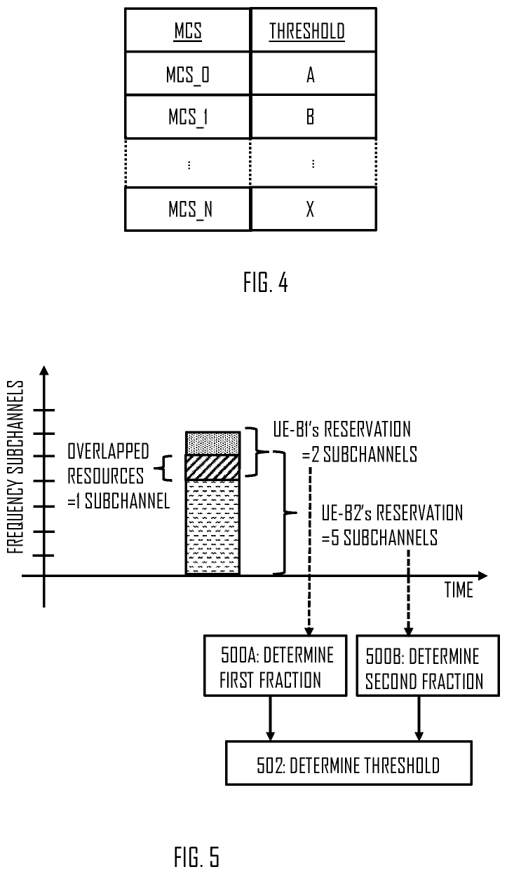

In an embodiment, the UE-A acquires first mapping information indicating a different threshold for each of a plurality of MCSs and determines the at least one threshold based on the first mapping information. The mapping information may be preconfigured at the UE-A, or provided to the UE-A from the network. The provision from the network may be via RRC signaling, for example. In an embodiment, the mapping information is in a form of a table, as shown in FIG. 4. This can also be called an offset table. As shown, the table may comprise, e.g., two columns listing different MCSs in one column and corresponding thresholds in another column. When the UE-A determines, e.g., that MCS_0 is to be used by UE-B1, then the UE may select the first threshold to be A. On the other hand, when the UEA determines, e.g., that MCS_N is to be used by UE-B2, then the UE may select the second threshold to be X, where X is higher than A. For example, the table may indicate a different threshold value to be used by UE-A depending on the MCS indicated by UE-B1's SCI, such that higher MCS values (i.e., less robust) correspond to higher threshold values (and consequently, as will be explained, the resource conflict indication may be triggered for higher RSRP ratios). The used references A-X for the thresholds are merely for illustration purposes. As said, the values for the available thresholds may be based testing or empirical statistics. The unit of the threshold may be dB, for example.

In an embodiment, the UE-A may detect that the reserved radio resources overlap at least partially. Further, in an embodiment, the UE-A may determine an extent of overlap between the first reserved radio resource and the second reserved radio resource. For example, in FIG. 2B, the UE-A may determine the amount/extent of resources in the overlapped resources marked with a block with right leaning diagonal lines. Then, in an embodiment, the UE-A may determine the at least one threshold further based on the determined extent of overlap. For example, if the overlap is small, then the threshold determined based on the relevant MCS may be adjusted by decreasing the threshold (so as not to provide the RCI so easily). Conversely, if the overlap is large, then the threshold determined based on the relevant MCS may be adjusted by increasing the threshold. This is because with high amount of resource overlap, the interference may be more severe, and the transmission of the RCI may be done more easily.

In an embodiment, the UE may determine in one or more of steps 500A, 500B, as shown in FIG. 5, at least one of a first fraction of the first reserved radio resource that overlaps with the second reserved radio resource, or a second fraction of the second reserved radio resource that overlaps with the first reserved radio resource. For example, in FIG. 5, the first fraction corresponds to 50%, as the overlapped resources (=1 subchannel) is half of the total reserved resources by UE-B1 (=2 subchannels). The second fraction corresponds to 20%, as the overlapped resources (=1 subchannel) is one fifth of the total reserved resources by UE-B2 (=5 subchannels). Subchannels are merely example frequency resource units, and other type of frequency resource granularity may be used. The UE-A may then in step 502 determine the at least one threshold further based on at least one of the first fraction or the second fraction. For example, the UE-A may adjust, based on the relevant fraction, the corresponding threshold, which may be initially obtained based on the respective MCS.

In an embodiment, the determined at least one threshold is proportional to at least one of the determined first fraction or the second fraction. For example, the condition(s) (1) and (2) may be amended in this embodiment as follows:
(1) RSRP_{B1} (dBm)−RSRP_{B2} (dBm)<Offset1(MCS_{B1}) (dB)+10 log₁₀(Lₒᵥₑᵣₗₐₚ/L_{subCH,B1}) (dB)
(2) RSRP_{B2} (dBm)−RSRP_{B1} (dBm)<Offset2(MCS_{B2}) (dB)+10 log₁₀(Lₒᵥₑᵣₗₐₚ/L_{subCH,B2}) (dB)

where Lₒᵥₑᵣₗₐₚ is the amount of overlapping resources and L_{subCH,B1} and L_{subCH,B2} are the total number of first and second reserved resources by UE-B1 and UE-B2, respectively. For example, if the fraction Lₒᵥₑᵣₗₐₚ/L_{subCH,B1} of overlapping subchannels for UE-B1 is small, UE-A's successful reception of UE-B1's transmission may tolerate a higher RSRP from UE-B2, for a given MCS_{B1}. This may mean that, for instance, if only half of UE-B1's reserved subchannels overlap with UE-B2's reserved resources (compared to a case where all of UE-B1's reserved subchannels would overlap), the threshold with respect to UE-B1 may be decreased by 3 dB, thus requiring an RSRP_{B2} twice as high (3 dB) for UE-A to trigger the resource conflict indication. Conversely, if the fraction is large (e.g., full overlap), UE-A's successful reception of UE-B1's transmission may require a lower RSRP from UE-B2, for a given MCS_{B1}. The same logic is applied to condition (2) depending on the fraction Lₒᵥₑᵣₗₐₚ/L_{subCH,B2} of overlapping subchannels for UE-B2.

In an embodiment, the determination of the threshold based on the respective fraction comprises adjusting, based on the relevant fraction, the corresponding threshold, which may be initially obtained based on the respective MCS. This adjusting may be done by the logarithmic functions as shown above in the conditions (1) and (2).

In an embodiment, the determination of the threshold based on the respective fraction may be based on second mapping information (e.g., a table). The UE-A may acquire the second mapping information indicating a different threshold for each of a plurality of different fractions. This information may be preconfigured at the UE-A or the UE-A may receive the second mapping information from the network. As one option, the table may look as shown in FIG. 6. As shown, the table may comprise, e.g., three columns listing different MCSs in the first column, different fractions of overlapping resources in the second column, and the corresponding threshold to be selected in the third column. When the UE-A determines, e.g., that MCS_0 is to be used by UE-B1, and the fraction of UE-B1's resource reservation overlapping with the UE-B2's resource reservation is 25%, then UE-A may select the first threshold to be A1. On the other hand, when the UE-A determines, e.g., that MCS_N is to be used by UE-B2, and the fraction of UE-B2's resource reservation overlapping with the UE-B1's resource reservation is 75%, then the UE-A may select the second threshold to be X3. It may be noted that X is higher than A, and, e.g., X2 is lower than X3. The used references A-X for the thresholds are merely for illustration purposes. The values for the available thresholds may be based on simulations/testing or statistics, for example. The unit of the threshold may be dB, for example. The granularity of the fractions may be based on implementation and vary from the shown 25% granularity. When the fraction does not correspond exactly to one of the available fraction percentages in the table, the fraction may be rounded to the nearest/next higher/next lower available tabulated fraction percentage option.

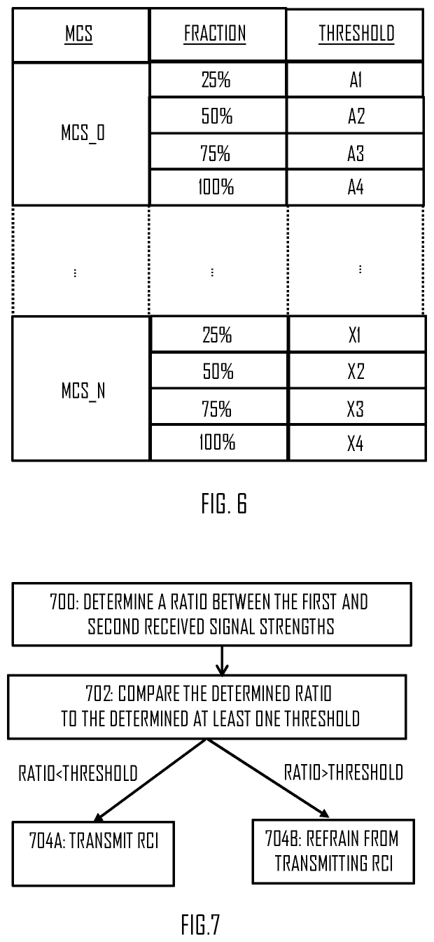

In an embodiment, as shown in FIG. 7, it is depicted how the UE-A determines if it transmits coordination information, e.g., the resource conflict indication (RCI), in step 312 of FIG. 3. It can be sent over PSFCH, as SCI or as MAC-CE, for example. According to the embodiment, the UE-A in step 700 determines a ratio between the first and second received signal strengths. This may comprise in one embodiment subtracting one measured signal strength from the other measured signal strength (e.g., expressed in dBm), as shown with conditions (1) and (2) above. This is only one manner of deriving the ratio, other manners may comprise a division function between the signal strengths (e.g., expressed in mW), for example.

In step 702, the UE-A compares the ratio to the determined at least one threshold. For example, according to condition (1) the UE-A may subtract the RSRP associated with the UE-B2 from the RSRP associated with the UE-B1 and compare that ratio (outcome of the subtraction) against the first threshold (which is the one that is associated with the UE-B1). As another example, according to condition (2) the UE-A may subtract the RSRP associated with the UE-B1 from the RSRP associated with the UE-B2 and compare that ratio (outcome of the subtraction) against the second threshold (which is the one that is associated with the UE-B2). First and second thresholds may be different, e.g., depending on what is the MCS and/or the fraction of overlap associated with the UE-B1 and UE-B2, respectively.

In step 704A, which is performed if the ratio meets a first condition with respect to the threshold (e.g., the ratio is below the threshold), the UE-A transmits the RCI to one or both of the UEs B1 and B2. In step 704B, which is performed if the ratio meets a second condition with respect to the threshold (e.g., the ratio is above the threshold), the UE-A refrains from transmitting the RCI. In some other implementations, depending on how the ratio is determined, the option 704A may be performed when the ratio is above the threshold and the option 704B when the ratio is below the threshold.

In aa embodiment, if the UE-A is not the intended receiver of the data transmission from the UE-B2 but is the intended receiver of the data transmission from the UE-B1, then the UE-A need not determine the second threshold but still monitor if the ratio is below the first threshold (relevant to the UE-B1). If it is, the UE-A triggers the transmission of the RCI to the UE-B1 and/or to the UE-B2.

As a consequence of sending the RCI, the receiver of the RCI may, e.g., reselect resources for the upcoming transmission so as to avoid the resource conflict. The indication may be a 1-bit indication of the resource conflict and/or it may comprise a suggestion for preferred or non-preferred resource re-selection. Details regarding how and which resources to reselect to avoid the resource conflict are considered known to a skilled person from IUC schemes and not discussed herein.

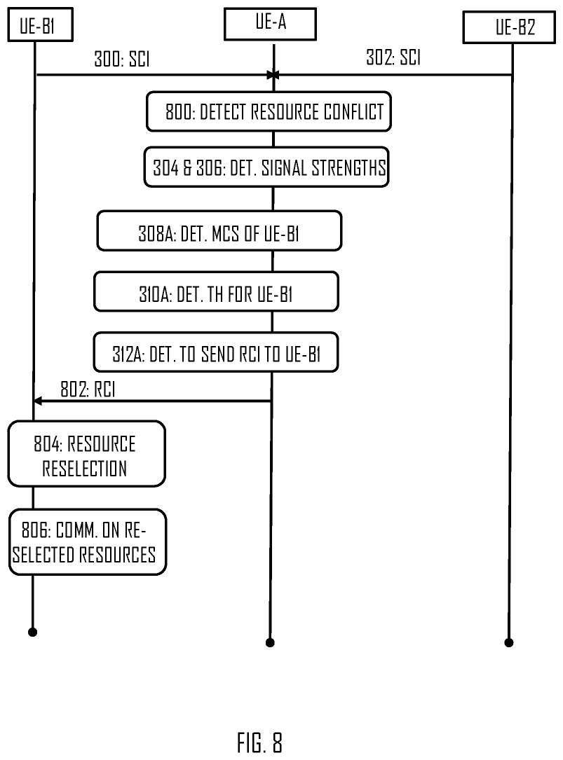

FIG. 8 shows a signaling flow diagram between the UEs A, B1 and B2 in the case where the UE-A considers the first threshold with respect to UE-B1. Steps 300-306 depict what has been explained in connection with FIG. 3. In step 800, the UE detects the upcoming resource conflict if both UE-B1 and UE-B2 transmit on the resources indicated in the respective SCIs. In step 308A, the UE-A determines the first MCS, i.e., the MCS to be used by the UE-B1 in its transmission on the first reserved resource, as explained in connection with step 308 of FIG. 3. In step 310A, the UE-A determines a first threshold for the UE-B1, as explained in connection with step 310 of FIG. 3. In step 312A, the UE-A decides whether or not to transmit the RCI (as explained in connection with step 312 of FIG. 3), and transmits the RCI to UE-B1 in step 802. Consequently, in steps 804 and 806, the UE-B1 reselects radio resources for the upcoming transmission and then transmits data on those reselected resources that avoid the resource conflict. Alternatively, the UE-A could have transmitted the RCI additionally or instead to UE-B2 in step 802, after which the UE-B2 could have reselected the resources.

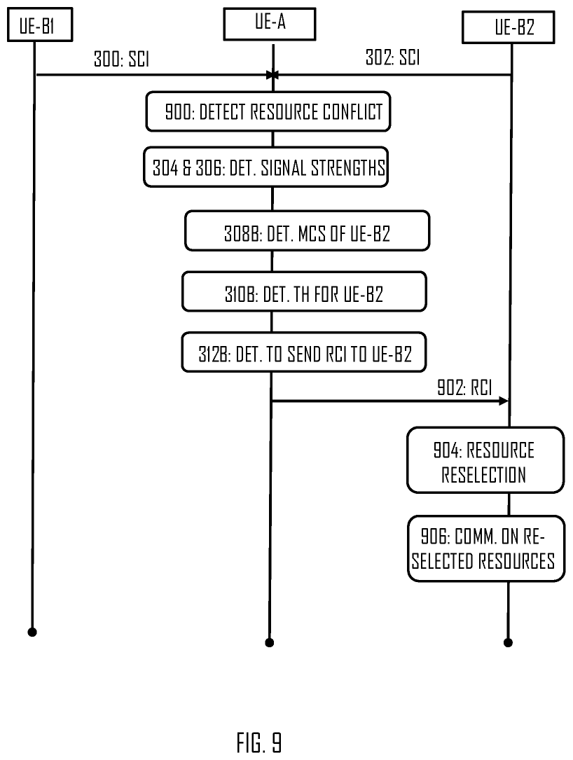

FIG. 9 shows a signaling flow diagram between the UEs A, B1 and B2 in the case where the UE-A considers the second threshold with respect to UE-B2. Steps 300-306 depict what has been explained in connection with FIG. 3. In step 900, the UE detects the upcoming resource conflict if both UE-B1 and UE-B2 transmit on the resources indicated in the respective SCIs. In step 308B, the UE-A determines the second MCS, i.e., the MCS to be used by the UE-B2 in its transmission on the second reserved resource, as explained in connection with step 308 of FIG. 3. In step 310B, the UE-A determines a second threshold for the UE-B2, as explained in connection with step 310 of FIG. 3. In step 312B, the UE-A decides whether or not to transmit the RCI (as explained in connection with step 312 of FIG. 3), and transmits the RCI to UE-B2 in step 902. Consequently, in steps 904 and 906, the UE-B2 reselects radio resources for the upcoming transmission and then transmits data on those reselected resources that avoid the resource conflict. Alternatively, the UE-A could have transmitted the RCI additionally or instead to UE-B1 in step 902, after which the UE-B1 could have reselected the resources.

Flow diagrams 8 and 9 can be combined such that the UE-A considers the first threshold against the UE-B1 and the second threshold against the UE-B2, and makes a decision on whether or not to transmit the RCI based on both considerations.

Some advantages of the embodiment may include enhancement of resource conflict indication (e.g., in IUC Scheme 2) by ensuring that UE-A (i.e., the UE detecting an expected/potential resource conflict) only indicates a conflict if UEA's successful reception is compromised. As shown above, this may require taking into account the MCS used by UE-B1/B2 (i.e., how robust the transmission is) and possibly also the fraction of overlapping subchannels (i.e., what is the real expected interference). This may advantageously reduce both false alarms and missed conflicts.

Although the embodiments have been described for two UEs (B1 and B2), there may be many UEs (B1, B2, B3, . . . , Bn) present in the scenario interfering each other's communication. In such case the UE-A may determine the thresholds for each of the UEs and if one or more triggers the RCI transmission, the UE may transmit the RCI to one or more of the interfering UEs.

It is further noted that although embodiments have been explained so that decrease in the threshold value causes the RCI to be sent less easily, depending on the implementation of how the signal strengths (e.g., the ratio) are used in comparison with the threshold, it may be that increment of the threshold affects so that the RCI is sent less easily. In such case, the more robust the MCS is, the higher is the determined threshold, for example. Further, the higher the fraction is, the lower is the relevant threshold, for example.

Although the embodiments are discussed in connection with D2D communication, the proposal is applicable to any inter-communications between network nodes, where one node detects overlapping resources and, thus, interference from two transmitting nodes. Such network nodes may be, e.g., base stations or relays, instead of the described UEs. In such case, the detecting BS-A may detect the intended resource reservations from other nodes (e.g., UEs or BSs) by monitoring the air interface and can then act as described in any of the described embodiments.

In one embodiment, the extent overlap (e.g., the first and/or second fraction) is used as the threshold setting criterion without determining the first or second MCS and without using the MCS as a criterion for determining the at least one threshold. In such case, the step 308 of FIG. 3 would comprise determining the extent of the overlap and step 310 would comprise determining at least one threshold based on the determined extent of overlap (e.g., based on the determined first and/or second fraction, as explained above). Otherwise FIG. 3 would be the same. The table of FIG. 6 would then need not comprise the MCS-column, but only a mapping between different fractions to different thresholds.

In an embodiment, the UE-A is configured to: a) receive a first SCI indicating a first reserved radio resource for transmission by the UE-B1 and measure a first RSRP associated with the received first SCI; b) receive a second SCI indicating a second reserved radio resource for transmission by the UE-B2 and measure a second RSRP associated with the received second SCI; c) determine that the first and second reserved radio resources overlap (e.g., they occur in a same time slot and have at least one common frequency subchannel); d) determine an RSRP ratio (e.g., RSRP difference, in dB) between the measured first and second RSRPs; and e) transmit a resource conflict indication to the UE-B1 and/or to the UE-B2, if the determined RSRP ratio is below a threshold, wherein the threshold is dependent on a first MCS indicated in the first SCI or a second MCS indicated in the second SCI. The threshold may be configured by means of a table indicating a different threshold value for each of a plurality of MCS values, wherein a higher MCS value corresponds to a higher threshold value. The UE-A may further be configured to determine a number of overlapping subchannels between the first and second reserved radio resources and the threshold is further dependent on the determined number of overlapping subchannels. The UE-A may further be configured to determine a first fraction of overlapping subchannels for the UE-B1 and/or a second fraction of overlapping subchannels for the UE-B2, wherein the threshold is further dependent on the determined first or second fraction of overlapping subchannels. In this case, the threshold may further be proportional to the determined first or second fraction of overlapping subchannels.

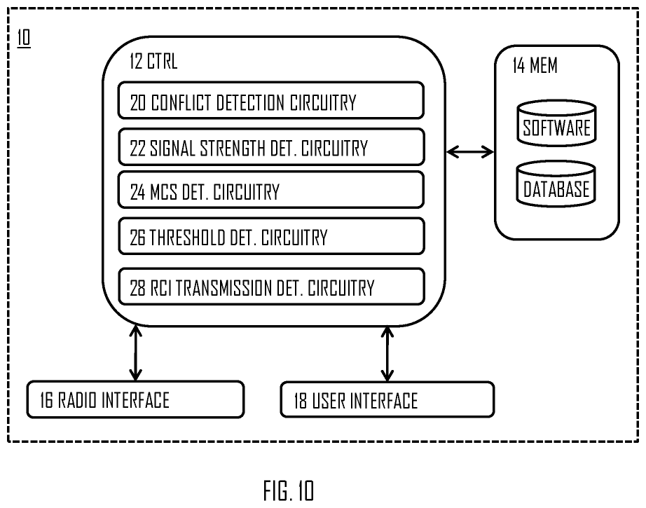

An embodiment, as shown in FIG. 10, provides an apparatus 10 comprising a control circuitry (CTRL) 12, such as at least one processor, and at least one memory 14 including a computer program code (software), wherein the at least one memory and the computer program code (software), are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 10 may comprise the terminal device of a communication system, e.g., a user terminal (UT), a computer (PC), a laptop, a tabloid computer, a cellular phone, a mobile phone, a communicator, a smart phone, a palm computer, a mobile transportation apparatus (such as a car), a household appliance, or any other communication apparatus, commonly called as UE in the description. Alternatively, the apparatus is comprised in such a terminal device. Further, the apparatus may be or comprise a module (to be attached to the UE) providing connectivity, such as a plug-in unit, an “USB dongle”, or any other kind of unit. The unit may be installed either inside the UE or attached to the UE with a connector or even wirelessly.

In an embodiment, the apparatus 10 is or is comprised in the UE-A. The apparatus may be caused to execute some of the functionalities of the above described processes.

The apparatus may further comprise a radio interface (TRX) 16 comprising hardware and/or software for realizing communication connectivity according to one or more communication protocols. The TRX may provide the apparatus with communication capabilities to access the radio access network, for example.

The apparatus may also comprise a user interface 18 comprising, for example, at least one keypad, a microphone, a touch display, a display, a speaker, etc. The user interface may be used to control the apparatus by the user.

The control circuitry 12 may comprise a conflict detection circuitry 20 for determining if there is a potential resource conflict, according to any of the embodiments. This circuitry may also be responsible of determining the amount of overlapped resources and the fraction of overlap, according to any of the embodiments. The control circuitry 12 may further comprise a signal strength determination circuitry 22 for determining signal strengths of received signals, according to any of the embodiments. The control circuitry 12 may further comprise a modulation and coding scheme determination circuitry 24 for determining MCSs used by other UEs, according to any of the embodiments. The control circuitry 12 may further comprise a threshold determination circuitry 26 for determining the at least one threshold, according to any of the embodiments. The control circuitry 12 may further comprise a RCI transmission determination circuitry 28 for determining whether or not to transmit the RCI, according to any of the embodiments.

As said, in an embodiment, the apparatus 10 may be or be comprised in a network node, such as in gNB/gNB-CU/gNB-DU of 5G. In an embodiment, the apparatus is or is comprised in the network node 110.

In an embodiment, a CU-DU (central unit—distributed unit) architecture is implemented. In such case the apparatus 10 may be comprised in a central unit (e.g., a control unit, an edge cloud server, a server) operatively coupled (e.g., via a wireless or wired network) to a distributed unit (e.g., a remote radio head/node). That is, the central unit (e.g., an edge cloud server) and the radio node may be stand-alone apparatuses communicating with each other via a radio path or via a wired connection. Alternatively, they may be in a same entity communicating via a wired connection, etc. The edge cloud or edge cloud server may serve a plurality of radio nodes or a radio access networks. In an embodiment, at least some of the described processes may be performed by the central unit. In another embodiment, the apparatus may be instead comprised in the distributed unit, and at least some of the described processes may be performed by the distributed unit. In an embodiment, the execution of at least some of the functionalities of the apparatus 10 may be shared between two physically separate devices (DU and CU) forming one operational entity. Therefore, the apparatus may be seen to depict the operational entity comprising one or more physically separate devices for executing at least some of the described processes. In an embodiment, the apparatus controls the execution of the processes, regardless of the location of the apparatus and regardless of where the processes/functions are carried out.

In an embodiment, an apparatus carrying out at least some of the embodiments described comprises at least one processor and at least one memory including a computer program code, wherein the at least one memory and the computer program code are configured, with the at least one processor, to cause the apparatus to carry out the functionalities according to any one of the embodiments described. According to an aspect, when the at least one processor executes the computer program code, the computer program code causes the apparatus to carry out the functionalities according to any one of the embodiments described. According to another embodiment, the apparatus carrying out at least some of the embodiments comprises the at least one processor and at least one memory including a computer program code, wherein the at least one processor and the computer program code perform at least some of the functionalities according to any one of the embodiments described. Accordingly, the at least one processor, the memory, and the computer program code form processing means for carrying out at least some of the embodiments described. According to yet another embodiment, the apparatus carrying out at least some of the embodiments comprises a circuitry including at least one processor and at least one memory including computer program code. When activated, the circuitry causes the apparatus to perform the at least some of the functionalities according to any one of the embodiments described.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry.

As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus, comprising:
at least one processor and at least one memory including a computer program code, wherein the at least one memory and the computer program code are configured, with the at least one processor, to cause the apparatus to perform:
receive a first sidelink control information, SCI, from a first device indicating a first reserved radio resource for transmission by the first device;
receive a second SCI from a second device indicating a second reserved radio resource for transmission by the second device, the second reserved radio resource overlapping at least partially with the first reserved radio resource;
determine a first received signal strength associated with the received first SCI;
determine a second received signal strength associated with the received second SCI;
determine at least one of a first modulation and coding scheme, MCS, applied by the first device or a second MCS applied by the second device;
determine, based on at least one of the first MCS or the second MCS, at least one threshold; and
determine, based on the at least one threshold and the determined first and second received signal strengths, whether or not to transmit a resource conflict indication to at least one of the first device or the second device.

2. The apparatus of claim 1, wherein the first received signal strength comprises a reference signal received power associated with the received first SCI, and the second received signal strength comprises a reference signal received power associated with the received second SCI.

3. The apparatus of claim 1, wherein the at least one memory and the computer program code are configured, with the at least one processor, to cause the apparatus further to perform at least one of:
determine the first MCS based on the received first SCI; or
determine the second MCS based on the received second SCI.

4. The apparatus of claim 1, wherein a more robust MCS corresponds to a lower threshold.

5. The apparatus of claim 1, wherein the at least one memory and the computer program code are configured, with the at least one processor, to cause the apparatus further to perform:
determine at least one of a first threshold associated with the first device based on the first MCS or a second threshold associated with the second device based on the second MCS.

6. The apparatus of claim 1, wherein the at least one memory and the computer program code are configured, with the at least one processor, to cause the apparatus further to perform:
acquire first mapping information indicating a different threshold for each of a plurality of MCSs; and
determine the at least one threshold based on the first mapping information.

7. The apparatus of claim 1, wherein the at least one memory and the computer program code are configured, with the at least one processor, to cause the apparatus further to:
determine an extent of overlap between the first reserved radio resource and the second reserved radio resource; and
determine the at least one threshold further based on the determined extent of overlap.

8. The apparatus of claim 1, wherein the at least one memory and the computer program code are configured, with the at least one processor, to cause the apparatus further to:
determine at least one of a first fraction of the first reserved radio resource that overlaps with the second reserved radio resource, or a second fraction of the second reserved radio resource that overlaps with the first reserved radio resource; and
determine the at least one threshold further based on at least one of the first fraction or the second fraction.

9. The apparatus of claim 8, wherein the determined at least one threshold is proportional to at least one of the determined first fraction or the second fraction.

10. The apparatus of claim 8, wherein the at least one memory and the computer program code are configured, with the at least one processor, to cause the apparatus further to:
acquire second mapping information indicating a different threshold for each of a plurality of different fractions; and
determine the at least one threshold further based on the second mapping information.

11. The apparatus of claim 1, wherein the at least one memory and the computer program code are configured, with the at least one processor, to cause the apparatus further to:
determine a ratio between the first and second received signal strengths;
compare the ratio to the determined at least one threshold; and
perform one of the following:
transmit the resource conflict indication when the ratio meets a first condition with respect to the threshold, or
refrain from transmitting the resource conflict indication when the ratio meets a second condition with respect to the threshold.

12. The apparatus of claim 1, wherein the apparatus is or is comprised in a user equipment.

13. A method, comprising:
receiving a first sidelink control information, SCI, from a first device indicating a first reserved radio resource for transmission by the first device;
receiving a second SCI from a second device indicating a second reserved radio resource for transmission by the second device, the second re-served radio resource overlapping at least partially with the first reserved radio resource;
determining a first received signal strength associated with the received first SCI;
determining a second received signal strength associated with the received second SCI;
determining at least one of a first modulation and coding scheme, MCS, applied by the first device or a second MCS applied by the second device;
determining, based on at least one of the first MCS or the second MCS, at least one threshold; and
determining, based on the at least one threshold and the determined first and second received signal strengths, whether or not to transmit a resource conflict indication to at least one of the first device or the second device.

14. The method of claim 13, further comprising at least one of:
determining the first MCS based on the received first SCI and determining the first threshold associated with the first device based on the first MCS; or
determining the second MCS based on the received second SCI and determining a second threshold associated with the second device based on the second MCS.

15. The method of claim 13, further comprising:
acquiring first mapping information indicating a different threshold for each of a plurality of MCSs; and
determining the at least one threshold based on the first mapping information.

16. The method of claim 13, further comprising:
determining an extent of overlap between the first reserved radio resource and the second reserved radio resource; and
determining the at least one threshold further based on the determined extent of overlap.

17. The method of claim 13, further comprising:
determining at least one of a first fraction of the first reserved radio resource that overlaps with the second reserved radio resource, or a second fraction of the second reserved radio resource that overlaps with the first reserved radio resource; and
determining the at least one threshold further based on at least one of the first fraction or the second fraction.

18. The method of claim 17, further comprising:
acquiring second mapping information indicating a different threshold for each of a plurality of different fractions; and
determining the at least one threshold further based on the second mapping information.

19. The method of claim 13, further comprising:
determining a ratio between the first and second received signal strengths;
comparing the ratio to the determined at least one threshold; and
performing one of the following:
transmitting the resource conflict indication when the ratio meets a first condition with respect to the threshold, or
refraining from transmitting the resource conflict indication when the ratio meets a second condition with respect to the threshold.

20. A non-transitory computer program product comprising program instructions which, when executed by an apparatus, cause the apparatus at least to:
receive a first sidelink control information, SCI, from a first device indicating a first reserved radio resource for transmission by the first device;
receive a second SCI from a second device indicating a second re-served radio resource for transmission by the second device, the second reserved radio resource overlapping at least partially with the first reserved radio resource;
determine a first received signal strength associated with the received first SCI;
determine a second received signal strength associated with the received second SCI;
determine at least one of a first modulation and coding scheme, MCS, applied by the first device or a second MCS applied by the second device;
determine, based on at least one of the first MCS or the second MCS, at least one threshold; and
determine, based on the at least one threshold and the determined first and second received signal strengths, whether or not to transmit a resource conflict indication to at least one of the first device or the second device.
